(19) United States
(12) Patent Application Publication
(10) Pub. No.: US 2017/0248991 A1
(43) Pub. Date: Aug. 31, 2017

(54) WEARABLE COMPUTING SYSTEM

(71) Applicant: Gen Nine, Inc., Louisville, KY (US)

(72) Inventor: Mark A. FAUCI, Louisville, KY (US)

(73) Assignee: Gen Nine, Inc., Louisville, KY (US)

(21) Appl. No.: 15/512,364

(22) PCT Filed: Sep. 17, 2015
(86) PCT No.: PCT/US2015/050724

§ 371 Date: Mar. 17, 2017

Related U.S. Application Data
(60) Provisional application No. 62/052,883, filed on Sep. 19, 2014.
(60) Provisional application No. 62/079,142, filed on Nov. 13, 2014.
(60) Provisional application No. 62/120,055, filed on Feb. 24, 2015.
(60) Provisional application No. 62/162,247, filed on May 15, 2015.

(51) Int. Cl. G06F 1/16; G02C 11/00; G02C 11/02

(52) U.S. Cl. CPC G06F 1/163; G02C 11/02; G02C 11/10

(57) ABSTRACT

The present disclosure describes wearable computing systems and devices. Wearable computing systems and devices can be modules with distinct functionalities that can be connected. The modules can be provided individually or in kit form to permit the user to configure a variety of wearable devices. Wearable computing systems and devices can include glasses, lanyards, necklaces, arm bands, and watches and can be attached to one another as needed.

### CROSS-REFERENCE TO RELATED APPLICATIONS

This application claims the benefit of priority to U.S. Provisional Patent Applications Ser. Nos. 62/052,883, filed on Sep. 19, 2014; 62/079,142, filed on Nov. 13, 2014; 62/120,055, filed on Feb. 24, 2015; and 62/162,247, filed on May 15, 2015, the contents of each of which is hereby incorporated by reference in its entirety.

### STATEMENT REGARDING FEDERALLY SPONSORED RESEARCH OR DEVELOPMENT

This invention was made with Government support under Award No. 1R44AG046969, awarded by the National Institute on Aging of the National Institutes of Health. The U.S. Government has certain rights in the invention.

### BACKGROUND

Wearable computing devices are emerging as an important technology category for consumer, health, industrial, and military applications. However, all systems and configurations require a highly-complex and time-consuming design and build process before becoming commercially-viable products. Moreover, all systems and configurations require removal of the device for re-charging, which can occur several times per day.

### SUMMARY OF THE INVENTION

In some embodiments, the invention provides a computing device comprising a first module and a second module, wherein the first module and the second module physically connect to provide an article of apparel that possesses an electronic computing functionality that the first and second modules do not possess when not physically connected; the computing device is wearable; at least one module comprises an electronic component; the first module comprises a first external housing that is in contact with an ambient environment; and the second module comprises a second external housing that is in contact with the ambient environment.

In some embodiments, the invention provides a method of assembling an article of apparel having an electronic computing functionality, the method comprising physically connecting a first module to a second module to provide the article of apparel having the electronic computing functionality, wherein the first module does not possess the electronic computing functionality when not physically connected to the second module; the second module does not possess the electronic computing functionality when not physically connected to the first module; at least one module comprises an electronic component; the first module comprises a first external housing that is in contact with an ambient environment; and the second module comprises a second external housing that is in contact with the ambient environment.

### BRIEF DESCRIPTION OF THE FIGURES

FIG. 1 PANELS A-B illustrate a series of modules.

FIG. 2 schematizes a modular wearable comprising an eyeglass connected to a lanyard.

FIG. 3 PANELS A-C illustrates eyeglass arm modules.

FIG. 4 illustrates module components.

FIG. 5 PANELS A-B illustrates modules for multi-purpose use.

FIG. 6 PANELS A-C illustrates an eyeglass device.

FIG. 7 illustrates an eyeglass and lanyard device.

FIG. 8 illustrates a lanyard head-mounted activity monitoring device connected eyeglasses.

FIG. 9 illustrates a lanyard head-mounted activity monitoring device connected over the ear.

FIG. 10 illustrates a necklace device.

FIG. 11 illustrates an eyeglass device.

FIG. 12 illustrates an eyeglass device.

FIG. 13 illustrates an eyeglass device.

### DETAILED DESCRIPTION

Presented herein is a method, system, or device comprising standardized modules that can snap together to form an unlimited number of potential wearable computing systems of various sizes, configurations, and functionalities, depending on user-driven requirements. These modules are provided individually or in kit form to permit the user to configure a variety of wearable devices including, for example, eyeglasses and jewelry. The modules can be assembled, disassembled, and then reassembled into different devices. Additional modules can be used to increase functionality, upgrade components, or even modify the visual appearance to accommodate changes in fashion.

The standardized modules can snap together to form various wearables, such as articles of apparel. Non-limiting examples of articles of apparel include headphones, hats, visors, eyeglasses, belts, lanyards, arm bands, and pieces of jewelry. Non-limiting examples of pieces of jewelry include earrings, necklaces, rings, bracelets, and watches.

In some embodiments, the method, system, or device described herein can comprise about 1 module, about 2 modules, about 3 modules, about 4 modules, about 5 modules, about 6 modules, about 7 modules, about 8 modules, about 9 modules, about 10 modules, about 11 modules, about 12 modules, about 13 modules, about 14 modules, about 15 modules, about 16 modules, about 17 modules, about 18 modules, about 19 modules, or about 20 modules. In some embodiments, the method, system, or device can comprise from about 1 module to about 2 modules, from about 2 modules to about 3 modules, from about 3 modules to about 4 modules, from about 4 modules to about 5 modules, from about 5 modules to about 6 modules, from about 6 modules to about 7 modules, from about 7 modules to about 8 modules, from about 8 modules to about 9 modules, from about 9 modules to about 10 modules, from about 10 modules to about 11 modules, from about 11 modules to about 12 modules, from about 12 modules to about 13 modules, from about 13 modules to about 14 modules, from about 14 modules to about 15 modules, from about 15 modules to about 16 modules, from about 16 modules to about 17 modules, from about 17 modules to about 18 modules, from about 18 modules to about 19 modules, from about 19 modules to about 20 modules.

In some embodiments, each module comprises one or more functional components. In some embodiments, the functional component is an electronic component. Non-limiting examples of electronic components include short message services (SMS), GPS, CPU, memory, display, such as LCD display, speakers, microphones, sensors, cameras, function or command buttons, wired or wireless communications, light sources, software application modules, battery, bone conduction transducers, pulse oximeters, thermometric sensors, calculators, barometric sensors, wire charging systems, and induction charging systems. In some embodiments, the module is a blank module to act as a spacer.

In some embodiments, the function capabilities of a method, system, or device disclosed herein are an electronic computing functionality. The functional capabilities of a method, system, or device disclosed herein can be divided into level one and level two functions. The division of functionality can allow a user to choose which set of capabilities is most suitable for the needs of the user. Further, appropriate battery capacity can be provided based on the functionality chosen by the user. Level one functions can include, for example, collection and analysis of activity and tracking data; collection of pulse-oximetry and temperature data; transmission of activity, tracking, pulse-oximetry, and temperature data to a central cloud server; and voice or text communication. Level two functions can include, for example, outdoor GPS tracking; data, voice, and text communication via a WiFi router; and data, voice, and text communication via a cellular network.

The user can snap different modules together to form a chain, panel, or vertical stack of modules to form three-dimensional configurations. Modules can be snapped together using male and female connections. Male connections can be specified by the presence of pins or prongs and female connections can be specified by the presence of holes into which the pins or prongs are inserted. The directionality of the male-female connection directs flow of power from the module or object comprising a male connection to the module or object comprising a female connection. In some embodiments, the male or female connection is a jack. In some embodiments, the male or female connection is a plug. In some embodiments, a male plug on a module is connected to a female jack on another module. In some embodiments, a male plug on a module is connected to a female jack on an object. In some embodiments, a male jack on an object is connected to a female plug on a module. Unused male and female ends can be covered, capped, or plugged with an innocuous material, such as rubber.

In some embodiments, the modules can have a housing to allow for external attachment to a device. The housing can comprise a material. Non-limiting examples of materials for the housing include plastics, metals, alloys, rubbers, and polymers. In some embodiments, the external housing is in contact with an ambient environment.

The housing can provide durability to the module in response to a stress. Non-limiting examples of stress to the module include mechanical stress, physical stress, temperature stress, barometric stress, water stress, and weather stress. Non-limiting examples of physical stress include damage from contact with a surface; damage caused by a substance; and damage caused by an animal. Non-limiting examples of damage-causing surfaces include walls, ceilings, floors, streets, sidewalks, and grounds. Non-limiting examples of damage-causing substances include rocks, sand, mud, dirt, soil, moss, grass, clay, loam, and gravel. Non-limiting examples of damage-causing animals include insects, spiders, dogs, cats, rodents, birds, livestock, horses, and humans. Non-limiting examples of temperature stress include heat resistance and cold resistance. Non-limiting examples of water stress include submersion in water and ambient atmospheric moisture. Non-limiting examples of weather stress include rain, snow, wind, ice, sleet, hail.

The modules can be of a physical structure. Non-limiting examples of physical structures of the module include hard, rigid, inflexible, smooth, soft, pliable, malleable, bendable, flexible, twistable, and moldable. In some embodiments, the module is hard. In some embodiments, the module is rigid. In some embodiments, the module is inflexible.

The modules can be used to form systems or devices that are worn, for example, on the wrist, neck, waist, or head, or panels large enough to cover entire parts of the body. Module size, shape, color, material, and finish can vary greatly depending on the functions and styles desired by the user. For example, a large, glass-faced LCD display module measuring two inches square can be attached to a string of half-inch stainless steel square modules containing CPU, memory, or sensors, for example, to form a watch system. This same chain can be disassembled and reassembled, with the addition or subtractions of modules, to form a necklace. Extreme shape and size variations can be achieved, such as a module shaped like a pair of pearl eyeglass frames.

The size of a module described herein can be about 0.1 square inches, about 0.2 square inches, about 0.3 square inches, about 0.4 square inches, about 0.5 square inches, about 0.6 square inches, about 0.7 square inches, about 0.8 square inches, about 0.9 square inches, about 1 square inch, about 1.1 square inches, about 1.2 square inches, about 1.3 square inches, about 1.4 square inches, about 1.5 square inches, about 1.6 square inches, about 1.7 square inches, about 1.8 square inches, about 1.9 square inches, about 2 square inches, about 2.1 square inches, about 2.2 square inches, about 2.3 square inches, about 2.4 square inches, about 2.5 square inches, about 2.6 square inches, about 2.7 square inches, about 2.8 square inches, about 2.9 square inches, about 3 square inches, about 3.1 square inches, about 3.2 square inches, about 3.3 square inches, about 3.4 square inches, about 3.5 square inches, about 3.6 square inches, about 3.7 square inches, about 3.8 square inches, about 3.9 square inches, about 4 square inches, about 4.1 square inches, about 4.2 square inches, about 4.3 square inches, about 4.4 square inches, about 4.5 square inches, about 4.6 square inches, about 4.7 square inches, about 4.8 square inches, about 4.9 square inches, or about 5 square inches.

The size of a module can be from about 0.1 square inches to about 0.2 square inches, from about 0.2 square inches to about 0.3 square inches, from about 0.3 square inches to about 0.4 square inches, from about 0.4 square inches to about 0.5 square inches, from about 0.5 square inches to about 0.6 square inches, from about 0.6 square inches to about 0.7 square inches, from about 0.7 square inches to about 0.8 square inches, from about 0.8 square inches to about 0.9 square inches, from about 0.9 square inches to about 1 square inch, from about 1 square inch to about 1.1 square inches, from about 1.1 square inches to about 1.2 square inches, from about 1.2 square inches to about 1.3 square inches, from about 1.3 square inches to about 1.4 square inches, from about 1.4 square inches to about 1.5 square inches, from about 1.5 square inches to about 1.6 square inches, from about 1.6 square inches to about 1.7 square inches, from about 1.7 square inches to about 1.8 square inches, from about 1.8 square inches to about 1.9 square inches, from about 1.9 square inches to about 2 square inches, from about 2 square inches to about 2.1 square inches, from about 2.1 square inches to about 2.2 square inches, from about 2.2 square inches to about 2.3 square inches, from about 2.3 square inches to about 2.4 square inches, from about 2.4 square inches to about 2.5 square inches, from about 2.5 square inches to about 2.6 square inches, from about 2.6 square inches to about 2.7 square inches, from about 2.7 square inches to about 2.8 square inches, from about 2.8 square inches to about 2.9 square inches, from about 2.9 square inches to about 3 square inches, from about 3 square inches to about 3.1 square inches, from about 3.1 square inches to about 3.2 square inches, from about 3.2 square inches to about 3.3 square inches, from about 3.3 square inches to about 3.4 square inches, from about 3.4 square inches to about 3.5 square inches, from about 3.5 square inches to about 3.6 square inches, from about 3.6 square inches to about 3.7 square inches, from about 3.7 square inches to about 3.8 square inches, from about 3.8 square inches to about 3.9 square inches, from about 3.9 square inches to about 4 square inches, from about 4 square inches to about 4.1 square inches, from about 4.1 square inches to about 4.2 square inches, from about 4.2 square inches to about 4.3 square inches, from about 4.3 square inches to about 4.4 square inches, from about 4.4 square inches to about 4.5 square inches, from about 4.5 square inches to about 4.6 square inches, from about 4.6 square inches to about 4.7 square inches, from about 4.7 square inches to about 4.8 square inches, from about 4.8 square inches to about 4.9 square inches, or from about 4.9 square inches to about 5 square inches.

The ability of a method, system, or device disclosed herein to form wearable objects can provide primary functions, for example, vision and fashion, that encourage wear in addition to the technical aspects of the objects. The objects of a system disclosed herein can also be worn in close proximity to the ears and mouth to allow access for microphones and speakers for communication functions, as well as skin proximity for pulse-oximetry and temperature sensors.

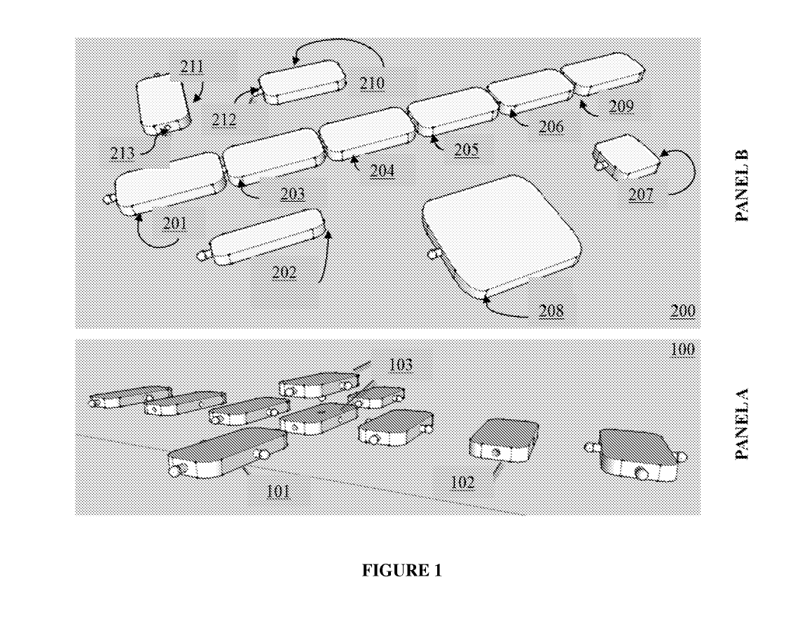

FIG. 1 illustrates a series of modules disclosed herein. PANEL A illustrates a set of modules 100, comprising an all-male connector module 101, an all-female connector module 102, and a vertical connector module 103. PANEL B illustrates a further set of modules 200, comprising a CPU module 201, a wireless cellphone module 202, a memory module 203, a sensor module 204, a battery module 205, a speaker module 206, a WiFi module 207, a LCD display module 208, a camera module 209, a Bluetooth™ module 210, a microphone module 211, a male connection 212, and a female connection 213.

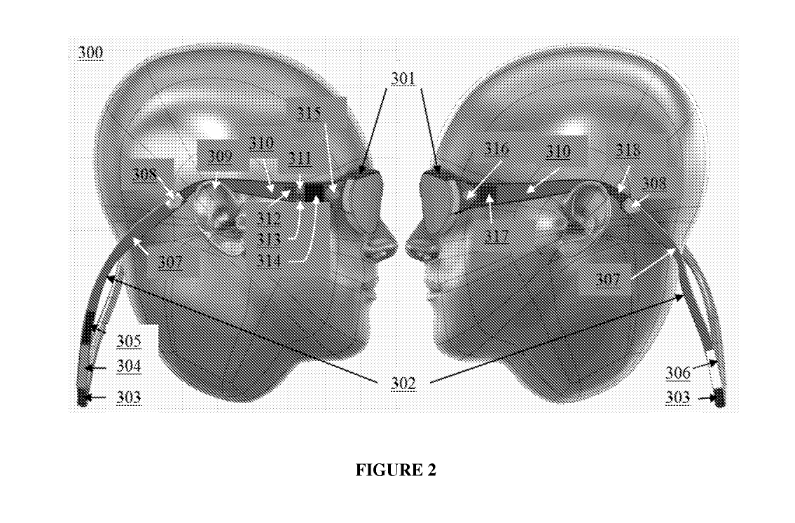

In some embodiments, the method, system, or device has an eyeglass configuration. An embodiment of an eyeglass configuration 300 is illustrated in FIG. 2. An eyeglass can comprise two subsystems to provide a wearable computing method, system, or device. The first subsystem can be a device resembling a pair of eyeglasses 301. The eyeglass configuration 301 can comprise modules including a pulse oximeter/temperature sensor 309, a battery 310, a 9-axis sensor 311, a memory 312, a second pulse oximeter/temperature sensor 313, a System on Chip (SoC) 314, a communications touch sensor 315, an accessory touch sensor 316, a GPS 317, and a Bluetooth™ antenna 318.

The second subsystem can be a lanyard 302 that can attach to the eyeglasses. The detachable lanyard 302 can add functionality and can supplement the power storage with a large array of batteries. The lanyard 302 can comprise modules including an induction charger 303, a cellular antenna 304, a WiFi antenna 305, a GPS antenna 306, a battery 307, and an induction transducer 308. The placement of a radio frequency (RF) antenna on the lanyard for use in, for example, cellular data, wireless communication, or GPS capabilities, can prevent the antenna from contacting the body. The placement of an antenna on the lanyard can improve the functionality of the antenna and mitigate concerns about safety.

The balance of components between the eyeglass 301 and lanyard 302 subsystems can be readily modified. A bone conducting transducer can be used for the receipt and broadcast of audio signals, and allow for communication in noisy environments. In some embodiments, all of the components can be embedded in the lanyard 302 subsystem, leaving no components embedded in the eyeglass 301 subsystem, or vice versa. If the lanyard 302 contains all of the components, then all functionality can be provided through the lanyard 302, allowing the lanyard to be attached to any pair of eyeglasses 301, for example.

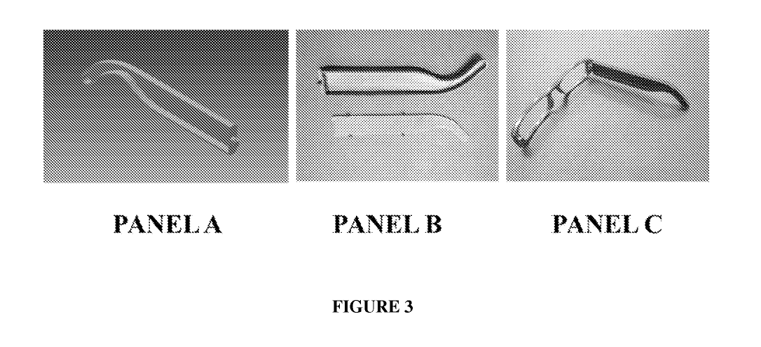

FIG. 3 PANELS A-C depict illustrative eyeglass arm modules for construction of an eyeglass configuration of a method, system, or device disclosed herein.

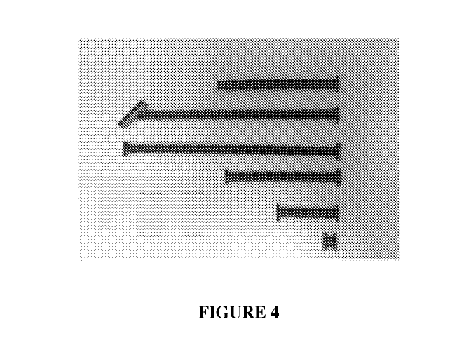

FIG. 4 depicts illustrative module components, which can be used to generate different systems or devices with different shapes, sizes, and functions.

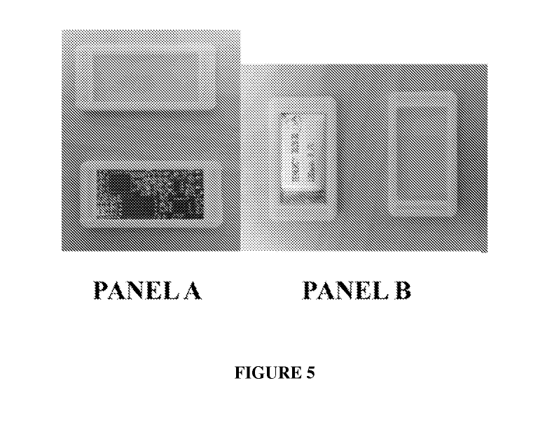

FIG. 5 PANEL A depicts illustrative examples of modules that can be used for functions, for example, with multiple processors and sensors. FIG. 5 PANEL B depicts an illustrative module for a single function, for example, battery storage.

Non-limiting examples of configurations of a method, system, or device disclosed herein include an eyeglass-only design with level one functionality, an eyeglass/lanyard combinations with level one and level two functionalities, a lanyard attached to ordinary eyeglasses with level one functionality, a lanyard attached to ordinary eyeglasses with level one and level two functionalities, a necklace with level one functionality, a necklace with level one and level two functionalities, an ear-mounted design with level one functionality, and an ear-mounted design with level one and level two functionalities.

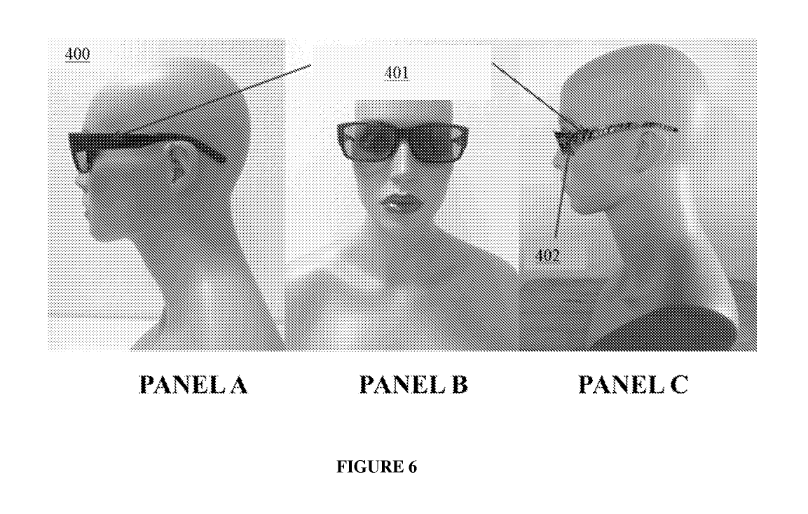

FIG. 6 depicts an eyeglass-only device 400, in which the eyeglass arms can be used to house all level one functional components 401, which can be attached to prescription or non-prescription front-frames and lenses. The electronic components and batteries can be embedded in the eyeglass arm modules as depicted in FIG. 3. The arm height 402 can be about 15 millimeters (mm) to accommodate the largest components of the invention. The eyeglass arm modules can be made in variety of shapes, sizes and designs to suit the user. The eyeglass frames can be made in a sunglasses shape (PANELS A-B) or a reading shape (PANEL C).

In some embodiments, the arm height of an eyeglass method, system, or device can be about 1 mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, about 25 mm, about 30 mm, about 35 mm, about 40 mm, about 45 mm, about 50 mm, about 55 mm, or about 60 mm. The arm height of an eyeglass method, system, or device can be from about 1 mm to about 2 mm, from about 2 mm to about 3 mm, from about 3 mm to about 4 mm, from about 4 mm to about 5 mm, from about 5 mm to about 6 mm, from about 6 mm to about 7 mm, from about 7 mm to about 8 mm, from about 8 mm to about 9 mm, from about 9 mm to about 10 mm, from about 11 mm to about 12 mm, from about 12 mm to about 13 mm, from about 13 mm to about 14 mm, from about 14 mm to about 15 mm, from about 15 mm to about 16 mm, from about 16 mm to about 17 mm, from about 17 mm to about 18 mm, from about 18 mm to about 19 mm, from about 19 mm to about 20 mm, from about 20 mm to about 25 mm, from about 25 mm to about 30 mm, from about 30 mm to about 35 mm, from about 35 mm to about 40 mm, from about 40 mm to about 45 mm, from about 45 mm to about 50 mm, from about 50 mm to about 55 mm, or from about 55 mm to about 60 mm

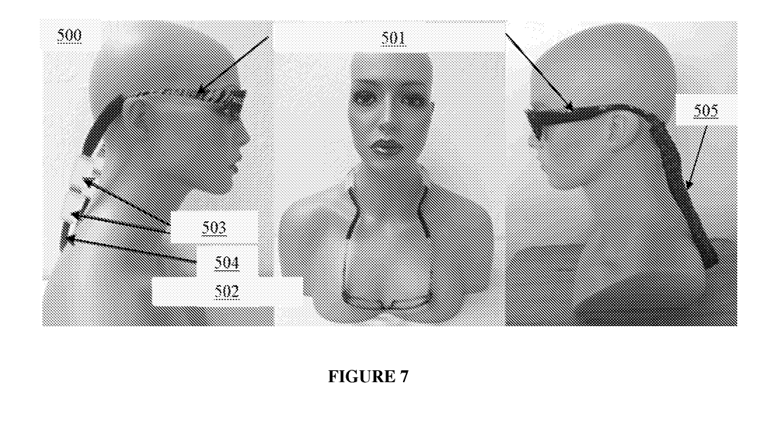

FIG. 7 depicts a device 500 in which the eyeglass arm modules can be similar to the eyeglass-only device illustrated in FIG. 6. The device 500 can include level one components 501 and level two components 502. The level two components 502 can include a functional or battery module 503 and an embedded antenna 504. The addition of the level two component 502 can add GPS, WiFi, and cellular communication functions, along with additional battery capacity and embedded antennae to support these functions. The level two components 502 can adapt to certain fashion enhancements such as removable, washable fabric covers 505 as well as a large variety of surface coatings and finishes that can give the device the appearance of jewelry.

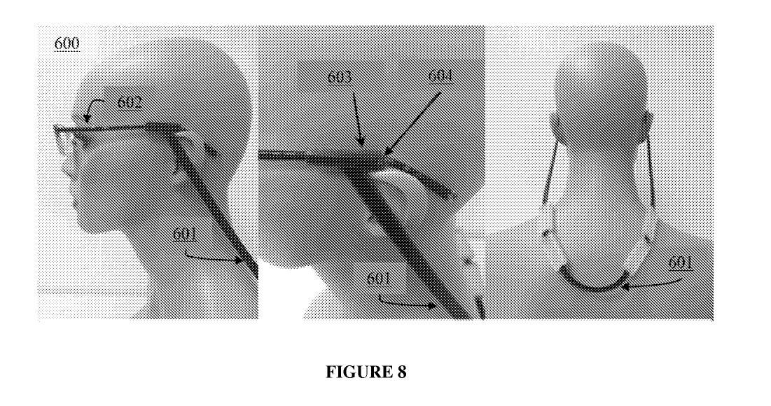

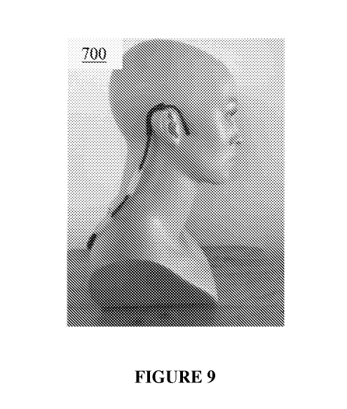

FIGS. 8 and 9 depicts a head-mounted activity monitoring (HAM) functionality completely embedded in a lanyard in a method, system, or device disclosed herein. FIG. 8 depicts a HAM device 600 comprising a dedicated lanyard 601 attached to the eyeglasses 602 of the user. The lanyard 601 can include a bone conduction microphone and speaker 603, and a pulse oximeter/temperature sensor 604. FIG. 9 depicts a HAM device 700, which is ear-mounted without the use of eyeglasses. The functionality of the lanyard can be both level one and level two.

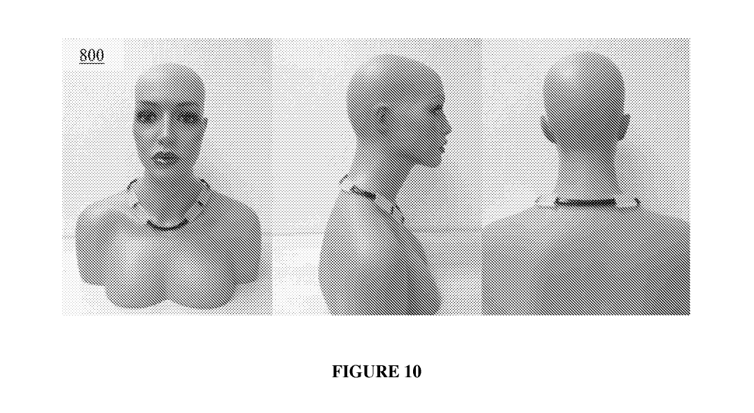

FIG. 10 depicts a necklace device 800 with level one and level two functionalities.

All of the modules of the present invention are designed to be interchangeable using standardized male and female connectors that permit quick and easy assembly, disassembly, upgrade, and modification using a physical or magnetic latching system. These connectors permit the transmission of power and communication between the modules. Communications between modules, or assembled systems worn on different areas of the body, for example, the wrist, waist, or head, and can also occur wirelessly, for example, via Bluetooth™. These connectors, when assembled, permit rotation around all three axes, allowing the resulting system to conform to body contours. Alternatively, these connectors can be selectively locked to allow a rigid array of modules. Other connector variations include semi-rigid, allowing bendability, and elastic, permitting the connection to stretch. Any or all of these connector types can be combined, permitting flexible, rigid, bendable, and elastic sections on the same system array.

In some embodiments, the connectors provide only communication functions or only power functions. In some embodiments, wherein no direct power transfer or communications occur between modules, each module can function as an independent sub-unit, containing an onboard power supply, for example, a battery, or an onboard wireless communication capability. This version permits modules or a system of modules to be placed anywhere on a body or in the proximity of a body and allow different modules or systems of modules to function as a system or a system of individual systems that can communicate with one another. In some embodiments, wireless components and protocols are configured to allow for variations in distance and bandwidth between modules or module systems.

In some embodiments, power transfer between modules is not necessary, because each module has an onboard power supply. In this case, a central system of software is used to collect data, for example, through wired or wireless communications from each module to provide user reports regarding the relative or absolute power storage and use profile for each independent module. In another case, lacking wired connections between modules, charge is transferred between modules, or between modules and a charging device, using inductive charging.

In some embodiments, a user can change CPU, increase memory storage, increase battery capacity, change the type or numbers of applications, for example, using preprogrammed modules or those with firmware, add a camera, add a speaker or add a display by including or removing modules. In some embodiments, material and finish can be modified to suit fashion preferences. In some embodiments, non-functional modules are used as space-fillers to increase the size of the system array.

In some embodiments, the system comprises of a pair of standardized eyewear frames that comprise sensors, processors, memory, other components or batteries, embedded in the frame. In some embodiments, capabilities are added to a non-component containing frame. In some embodiments, in which the case of frames already contains functional components, the frames are augmented with additional capabilities and components through the addition of modules that snap on and off the frame using a physical or magnetic latching system. These modules form an unlimited number of potential wearable computing systems of various functions and sizes.

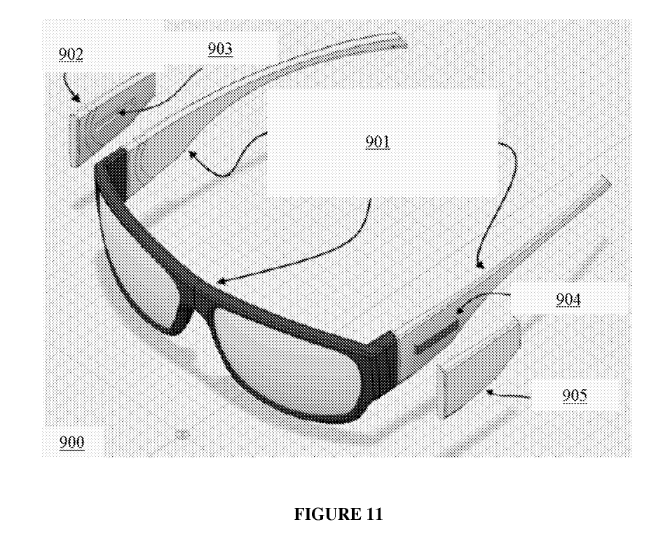

FIG. 11 depicts an eyeglass device 900 designed with side-paneled modules. The device can comprise an eyeglass frame 901 with embedded modules. The eyeglass frame 901 can be functional or non-functional as eyeglasses. The embedded modules can include a function control module 902 with a female connector 903 and a battery module 904, with the eyeglass frame 901 having a male connector 905.

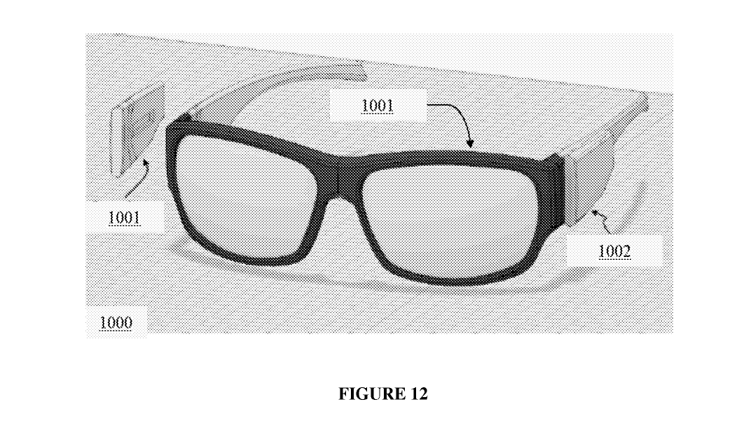

FIG. 12 depicts an eyeglass device 1000 designed with side-paneled modules. The device can comprise an eyeglass frame 1001 with embedded modules. The eyeglass frame 1001 can be functional or non-functional as eyeglasses. The embedded modules can include a sensor module 1002 and a memory module 1003.

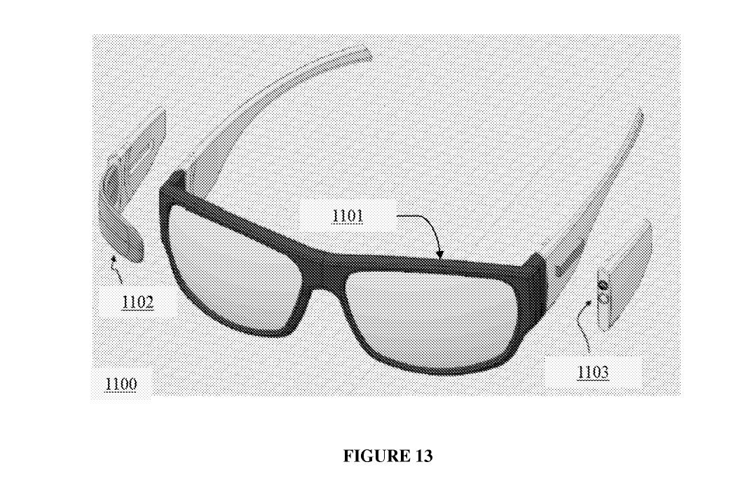

FIG. 13 depicts an eyeglass device 1100 designed with side-paneled modules. The device can comprise an eyeglass frame 1101 with embedded modules. The eyeglass frame 1101 can be functional or non-functional as eyeglasses. The embedded modules can include a display module 1102 and a camera module with a light source 1103.

Additional combinations of modules are possible, and these embodiments should not be considered limiting. Other modules and their configurations and functionalities can depend on user requirements. In some embodiments, these modules are provided individually or in kit form to permit a user to configure a variety of wearable devices. A user can assemble modules into different devices. In some embodiments, additional modules serve to expand functionality, upgrade components or modify the visual appearance to accommodate changes in fashion.

In some embodiments, each module comprises one or more functional components. A list of non-limiting examples comprises: CPU; memory; display; speakers; microphones; sensors; cameras; function or command buttons; wired or wireless communications; light sources; software application modules; batteries; digital projector; GPS; cellular activity; and antenna activity.

In some embodiments, the modules of this disclosure are designed to be interchangeable using standardized male and female connections. These connections permit the modules to be rapidly and easily assembled, disassembled, upgraded and modified using a physical or magnetic latching system. These connectors permit the transmission of power and communication between the modules and between the eyeglass frame components and modules.

In some embodiments, the connections provide, for example, communications functions, power functions, sensor functions, camera functions, or other functions. Non-limiting examples of communications functions include wireless communications functions, voice communications functions, and natural language interface functions. Non-limiting examples of sensor functions include thermometer functions, pulse-oximeter functions, accelerometer functions, e-gyrometer functions, magnetometer functions, inclinometer functions, and barometer functions. In some embodiments, in which there are no direct power or communications connections between the frame and modules, each module functions as a completely independent sub-unit, containing an onboard power supply (for example, a battery) or onboard wireless communications capability. In some embodiments, modules, or system of modules, communicate with the frame or one another wirelessly or with other wireless devices.

In some embodiments, individual modules have their own onboard power supply. In some embodiments, a central system of software is used to collect data (for example, through wired or wireless communications) from each module to provide user reports regarding the relative or absolute power storage and use profile for each independent module. In some embodiments, in the absence of wired connections between module and frame, charge is transferred between modules and frame, or between modules and a charging device, using inductive charging.

In some embodiments, two modules are connected with a functional or non-functional lanyard that extends around the back of a user's head. In some embodiments, the lanyard provides power transfer or communications between modules or comprises one or more functional components. A list of non-limiting examples comprises: CPU; memory; display; speakers; microphones; sensors; cameras; function or command buttons; wired or wireless communications; light sources; software application modules; batteries; digital projector; GPS; cellular activity; and antenna activity.

### EMBODIMENTS

The following non-limiting embodiments provide illustrative examples of the invention, but do not limit the scope of the invention.

### Embodiment 1

A computing device comprising a first module and a second module, wherein a) the first module and the second module physically connect to provide an article of apparel that possesses an electronic computing functionality that the first and second modules do not possess when not physically connected; b) the computing device is wearable; c) at least one module comprises an electronic component; d) the first module comprises a first external housing that is in contact with an ambient environment; and e) the second module comprises a second external housing that is in contact with the ambient environment.

### Embodiment 2

The device of Embodiment 1, wherein the first module physically connects to the second module through a male/female connection.

### Embodiment 3

The device of Embodiment 1 or Embodiment 2, wherein the first module and the second module each comprise a different electronic component.

### Embodiment 4

The device of Embodiment 1 or Embodiment 2, wherein the first module and the second module each comprise a same electronic component.

### Embodiment 5

The device of any one of Embodiments 1-4, wherein the electronic component comprises a CPU function.

### Embodiment 6

The device of any one of Embodiments 1-4, wherein the electronic component comprises a SMS function.

### Embodiment 7

The device of any one of Embodiments 1-4, wherein the electronic component comprises a GPS function.

### Embodiment 8

The device of any one of Embodiments 1-4, wherein the electronic component comprises a memory function.

### Embodiment 9

The device of any one of Embodiments 1-4, wherein the electronic component comprises a display function.

### Embodiment 10

The device of any one of Embodiments 1-4, wherein the electronic component comprises a speaker function.

### Embodiment 11

The device of any one of Embodiments 1-4, wherein the electronic component comprises a microphone function.

### Embodiment 12

The device of any one of Embodiments 1-4, wherein the electronic component comprises a camera function.

### Embodiment 13

The device of any one of Embodiments 1-4, wherein the electronic component comprises a communications function.

### Embodiment 14

The device of Embodiment 13, wherein the communications function is chosen from: wireless communications function, voice communications function, and natural language interface function.

### Embodiment 15

The device of any one of Embodiments 1-4, wherein the electronic component comprises a software application function.

### Embodiment 16

The device of any one of Embodiments 1-4, wherein the electronic component comprises a battery function.

### Embodiment 17

The device of any one of Embodiments 1-4, wherein the electronic component module comprises a sensor function.

### Embodiment 18

The device of Embodiment 17, wherein the sensor function is chosen from: thermometer function, pulse-oximeter function, accelerometer function, e-gyrometer function, magnetometer function, inclinometer function, and barometer function.

### Embodiment 19

The device of any one of Embodiments 1-4, wherein the electronic component comprises an induction charging function.

### Embodiment 20

The device of any one of Embodiments 1-19, further comprising a blank module with a spacer function.

### Embodiment 21

The device of any one of Embodiments 1-20, wherein the article of apparel is a pair of eyeglasses.

### Embodiment 22

The device of any one of Embodiments 1-20, wherein the article of apparel is a lanyard.

### Embodiment 23

The device of any one of Embodiments 1-20, wherein the article of apparel is a headphone.

### Embodiment 24

The device of any one of Embodiments 1-20, wherein the article of apparel is a visor.

### Embodiment 25

The device of any one of Embodiments 1-20, wherein the article of apparel is a belt.

### Embodiment 26

The device of any one of Embodiments 1-20, wherein the article of apparel is an arm band.

### Embodiment 27

The device of any one of Embodiments 1-20, wherein the article of apparel is a piece of jewelry.

### Embodiment 28

A method of assembling an article of apparel having an electronic computing functionality, the method comprising physically connecting a first module to a second module to provide the article of apparel having the electronic computing functionality, wherein a) the first module does not possess the electronic computing functionality when not physically connected to the second module; b) the second module does not possess the electronic computing functionality when not physically connected to the first module; c) at least one module comprises an electronic component; d) the first module comprises a first external housing that is in contact with an ambient environment; and e) the second module comprises a second external housing that is in contact with the ambient environment.

### Embodiment 29

The method of Embodiment 28, wherein the first module physically connects to the second module through a male/female connection.

### Embodiment 30

The method of Embodiment 28 or Embodiment 29, wherein the first module and the second module each comprise a different electronic component.

### Embodiment 31

The method of Embodiment 28 or Embodiment 29, wherein the first module and the second module each comprise a same electronic component.

### Embodiment 32

The method of any one of Embodiments 28-31, wherein the electronic component comprises a CPU function.

### Embodiment 33

The method of any one of Embodiments 28-31, wherein the electronic component comprises a SMS function.

### Embodiment 34

The method of any one of Embodiments 28-31, wherein the electronic component comprises a GPS function.

### Embodiment 35

The method of any one of Embodiments 28-31, wherein the electronic component comprises a memory function.

### Embodiment 36

The method of any one of Embodiments 28-31, wherein the electronic component comprises a display function.

### Embodiment 37

The method of any one of Embodiments 28-31, wherein the electronic component comprises a speaker function.

### Embodiment 38

The method of any one of Embodiments 28-31, wherein the electronic component comprises a microphone function.

### Embodiment 39

The method of any one of Embodiments 28-31, wherein the electronic component comprises a camera function.

### Embodiment 40

The method of any one of Embodiments 28-31, wherein the electronic component comprises a communications function.

### Embodiment 41

The method of Embodiment 40, wherein the communications function is: wireless communications function, voice communications function, and natural language interface function.

### Embodiment 42

The method of any one of Embodiments 28-31, wherein the electronic component comprises a software application function.

### Embodiment 43

The method of any one of Embodiments 28-31, wherein the electronic component comprises a battery function.

### Embodiment 44

The method of any one of Embodiments 28-31, wherein the electronic component module comprises a sensor function.

### Embodiment 45

The method of Embodiment 44, wherein the sensor function is chosen from: thermometer function, pulse-oximeter function, accelerometer function, e-gyrometer function, magnetometer function, inclinometer function, and barometer function.

### Embodiment 46

The method of any one of Embodiments 28-31, wherein the electronic component comprises an induction charging function.

### Embodiment 47

The method of any one of Embodiments 28-46, wherein the article of apparel further comprises a blank module with a spacer function.

### Embodiment 48

The method of any one of Embodiments 28-47, wherein the article of apparel is a pair of eyeglasses.

### Embodiment 49

The method of any one of Embodiments 28-47, wherein the article of apparel is a lanyard.

### Embodiment 50

The method of any one of Embodiments 28-47, wherein the article of apparel is a headphone.

### Embodiment 51

The method of any one of Embodiments 28-47, wherein the article of apparel is a visor.

### Embodiment 52

The method of any one of Embodiments 28-47, wherein the article of apparel is a belt.

### Embodiment 53

The method of any one of Embodiments 28-47, wherein the article of apparel is an arm band.

### Embodiment 54

The method of any one of Embodiments 28-47, wherein the article of apparel is a piece of jewelry.

What is claimed is:

1. A computing device comprising a first module and a second module, wherein:
a) the first module and the second module physically connect to provide an article of apparel that possesses an electronic computing functionality that the first and second modules do not possess when not physically connected;
b) the computing device is wearable;
c) at least one module comprises an electronic component;
d) the first module comprises a first external housing that is in contact with an ambient environment; and
e) the second module comprises a second external housing that is in contact with the ambient environment.

2. The device of claim 1, wherein the first module physically connects to the second module through a male/female connection.

3. The device of claim 1, wherein the first module and the second module each comprise a different electronic component.

4. The device of claim 1, wherein the first module and the second module each comprise a same electronic component.

5. The device of claim 1, wherein the electronic component comprises a CPU function.

6. The device of claim 1, wherein the electronic component comprises a SMS function.

7. The device of claim 1, wherein the electronic component comprises a GPS function.

8. The device of claim 1, wherein the electronic component comprises a memory function.

9. The device of claim 1, wherein the electronic component comprises a display function.

10. The device of claim 1, wherein the electronic component comprises a speaker function.

11. The device of claim 1, wherein the electronic component comprises a microphone function.

12. The device of claim 1, wherein the electronic component comprises a camera function.

13. The device of claim 1, wherein the electronic component comprises a communications function.

14. The device of claim 13, wherein the communications function is chosen from: wireless communications function, voice communications function, and natural language interface function.

15. The device of claim 1, wherein the electronic component comprises a software application function.

16. The device of claim 1, wherein the electronic component comprises a battery function.

17. The device of claim 1, wherein the electronic component module comprises a sensor function.

18. The device of claim 17, wherein the sensor function is chosen from: thermometer function, pulse-oximeter function, accelerometer function, e-gyrometer function, magnetometer function, inclinometer function, and barometer function.

19. The device of claim 1, wherein the electronic component comprises an induction charging function.

20. The device of claim 1, further comprising a blank module with a spacer function.

21. The device of claim 1, wherein the article of apparel is a pair of eyeglasses.

22. The device of claim 1, wherein the article of apparel is a lanyard.

23. The device of claim 1, wherein the article of apparel is a headphone.

24. The device of claim 1, wherein the article of apparel is a visor.

25. The device of claim 1, wherein the article of apparel is a belt.

26. The device of claim 1, wherein the article of apparel is an arm band.

27. The device of claim 1, wherein the article of apparel is a piece of jewelry.

28. A method of assembling an article of apparel having an electronic computing functionality, the method comprising physically connecting a first module to a second module to provide the article of apparel having the electronic computing functionality, wherein:
a) the first module does not possess the electronic computing functionality when not physically connected to the second module;
b) the second module does not possess the electronic computing functionality when not physically connected to the first module;
c) at least one module comprises an electronic component;
d) the first module comprises a first external housing that is in contact with an ambient environment; and
e) the second module comprises a second external housing that is in contact with the ambient environment.

29. The method of claim 28, wherein the first module physically connects to the second module through a male/female connection.

30. The method of claim 28, wherein the first module and the second module each comprise a different electronic component.

31. The method of claim 28, wherein the first module and the second module each comprise a same electronic component.

32. The method of claim 28, wherein the electronic component comprises a CPU function.

33. The method of claim 28, wherein the electronic component comprises a SMS function.

34. The method of claim 28, wherein the electronic component comprises a GPS function.

35. The method of claim 28, wherein the electronic component comprises a memory function.

36. The method of claim 28, wherein the electronic component comprises a display function.

37. The method of claim 28, wherein the electronic component comprises a speaker function.

38. The method of claim 28, wherein the electronic component comprises a microphone function.

39. The method of claim 28, wherein the electronic component comprises a camera function.

40. The method of claim 28, wherein the electronic component comprises a communications function.

41. The method of claim 40, wherein the communications function is chosen from: wireless communications function, voice communications function, and natural language interface function.

42. The method of claim 28, wherein the electronic component comprises a software application function.

43. The method of claim 28, wherein the electronic component comprises a battery function.

44. The method of claim 28, wherein the electronic component module comprises a sensor function.

45. The method of claim 44, wherein the sensor function is chosen from: thermometer function, pulse-oximeter function, accelerometer function, e-gyrometer function, magnetometer function, inclinometer function, and barometer function.

46. The method of claim 28, wherein the electronic component comprises an induction charging function.

47. The method of claim 28, wherein the article of apparel further comprises a blank module with a spacer function.

48. The method of claim 28, wherein the article of apparel is a pair of eyeglasses.

49. The method of claim 28, wherein the article of apparel is a lanyard.

50. The method of claim 28, wherein the article of apparel is a headphone.

51. The method of claim 28, wherein the article of apparel is a visor.

52. The method of claim 28, wherein the article of apparel is a belt.

53. The method of claim 28, wherein the article of apparel is an arm band.

54. The method of claim 28, wherein the article of apparel is a piece of jewelry.
